(19) United States
(12) Patent Application Publication
(10) Pub. No.: US 2009/0063614 A1
(43) Pub. Date: Mar. 5, 2009

(54) Efficiently Distributing Class Files Over A Network Without Global File System Support

(75) Inventors: Christopher M. Donawa, Burnaby (CA); Allan H. Kielstra, Ajax (CA); C. Brian Hall, Calgary (CA)

Correspondence Address: CANTOR COLBURN LLP - IBM AUSTIN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/845,573

(22) Filed: Aug. 27, 2007

(51) Int. Cl. G06F 15/173

(52) U.S. Cl. 709/202

(57) ABSTRACT

A system and method for distributing class files in a network to multiple recipients without global file system support are provided. A root node includes a virtual machine, is configured to receive network topology information for all nodes in the network, and obtains class files. First level nodes include virtual machines, are coupled to the root node, and are one distribution level below the root node. Second level nodes include virtual machines, are coupled to the first level nodes, and are one distribution level below the first nodes. Nth level nodes include virtual machines, are coupled to the second level nodes. N is representative of a continuous succession of distribution levels for nodes through a last node in network. The root node distributes the class files to first level nodes, which distribute the class files to the second level nodes, which distribute the class files to the nth level nodes.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND

An exemplary embodiment of this invention relates to distributing files over a network, and particularly to a system and a method for distributing files to remote machines without using a global file system.

For large computational problems that scale beyond a symmetrical multiprocessor's (SMP) capability (e.g., beyond 32 or 64 processing units), it is necessary to install the program to be run on all the remote nodes participating in the program. For java, this means a virtual machine (VM) on each node, and the class files must be installed on each node as well. Typically, a global file system is in place and the class files are distributed via the global file system to all the networked computers that are participating. Then a system, such as IBM's® parallel operating environment (POE), is used to start up the VM on each node, and the class files are loaded and the program run. An alternative is to have a root VM that communicates with all the remote VMs and sends the byte codes (which is machine-independent code generated by the Java compiler and executed by the Java interpreter) to the remote VMs.

In the first case, the global (shared) file system is a significant infrastructure that must be implemented and maintained. In the second case, there is a scalability issue if there are too many remote VMs requesting the class files simultaneously from the root VM, and the root VM may be overwhelmed.

It is desirable to have a scalable way of distributing class files to remote virtual machines without a global file system.

### SUMMARY

In accordance with an exemplary embodiment, a system for distributing class files in a network to multiple recipients without global file system support is provided. A root node includes a virtual machine, and the root node is configured to receive network topology information concerning all nodes in the network and to obtain class files. First level nodes include virtual machines, and the first level nodes are operatively coupled to the root node and are one distribution level below the root node. Second level nodes include virtual machines, and the second level nodes are operatively coupled to the first level nodes and are one distribution level below the first nodes. Nth level nodes include virtual machines, and the nth level nodes are operatively coupled to the second level nodes and n is representative of a continuous succession of distribution levels for nodes through a last node in the network topology.

Further in the system, the root node initiates the first level nodes, the first level nodes initiate the second level nodes, and the second level nodes initiate the nth level nodes, and/or the root node, the first level nodes, the second level nodes, and the nth level nodes are continually running. In response to receiving a request to the root node, the root node distributes the class files to the first level nodes and caches the class files. In response to receiving a request to the first level nodes, the first level nodes distribute the class files to the second level nodes and cache the class files. In response to receiving a request to the second level nodes, the second level nodes distribute the class files to the nth level nodes and cache the class files. The nth level nodes cache the class files.

In accordance with the exemplary embodiment, a method for distributing class files in a network to a plurality of recipients without global file system support is provided. Network topology information is received about all nodes in the network by a root node comprising a virtual machine. A root node receives class files. First level nodes are operatively coupled to the root node. The first level nodes include virtual machines and are one distribution level below the root node. Second level nodes are operatively coupled to the first level nodes. The second level nodes include virtual machines and are one distribution level below the first nodes. Nth level nodes are operatively coupled to the second level nodes. The nth level nodes include virtual machines and n represents a continuous succession of distribution levels for the nodes.

Further in the method, the root node initiates the first level nodes, the first level nodes initiate the second level nodes, and the second level nodes initiate the nth level nodes, and/or the root node, the first level nodes, the second level nodes, and the nth level nodes are continually running. The class files are distributed to the first level nodes by the root node in response to receiving a request to the root node, and the class files are cached by the root node. The class files are distributed to the second level nodes by the first level nodes in response to receiving a request to the first level nodes, and the class files are cached by the first level nodes. The class files are distributed to the nth level nodes by the second level nodes in response to receiving a request to the second level nodes. The class files are cached by the second level nodes and the class files are cached by the nth level nodes.

Additional features and advantages are realized through the techniques discussed herein. Other embodiments and aspects are described in detail herein and are considered a part of the claimed invention. For a better understanding of exemplary embodiments with advantages and features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages discussed herein are apparent from the following detailed description taken in conjunction with the accompanying drawings in which:

FIG. 1 illustrates an exemplary distribution tree in accordance with the exemplary embodiment;

FIG. 2 illustrates a non-limiting example of a node in accordance with the exemplary embodiment; and

FIG. 3 illustrates a method for distributing class files without global file system support in accordance with the exemplary embodiment.

The detailed description explains the exemplary embodiments of the invention, together with advantages and features, by way of example with reference to the drawings.

### DETAILED DESCRIPTION OF THE EXEMPLARY EMBODIMENT

For a Java program (or any programs with managed runtimes) to be scalable past existing SMP limits, the Java program needs to support distributed algorithms, whether using message passing interface (MPI) style libraries or systems such as X10 (which is a modern object-oriented programming language). An exemplary embodiment describes how to distribute the program (e.g., a Java program) to a set of networked processors without use of a distributed file system, although how the program actually exploits these computing resources is of course up to the programmer.

In the exemplary embodiment, the system may start with a single root VM. The root VM contains all needed class files, has knowledge of all the remote VMs participating in the system, and has knowledge of the network latencies and network bandwidth between each of the nodes. The root VM creates an internal representation (e.g., a distribution tree) of the remote VMs, based on this network knowledge. This tree is used to determine how to share the responsibilities of distributing class files in a scalable manner. Each node in the tree corresponds to a computer node in the network (or maybe to a VM). Each node receives its class files from its parent (which is a node higher up the distribution chain), and sends class files as requested to its children (which are nodes immediately below the parent node in the distribution chain). In the exemplary embodiment, each node becomes a repository for class files, and shares the burden of distribution. In accordance with the exemplary embodiment, distributing class files in a scalable manner denotes that the distribution of class files is performed efficiently regardless of the number of nodes participating. Indeed, as the number of nodes increases, the mechanism for distributing the class files does not introduce bottlenecks in the performance of the system. As a non-limiting example, one node may be able to easily distribute class files to a small number of other nodes, but may be temporarily overwhelmed if asked to distribute the class files to a large number of nodes. Processing on the other nodes will also be affected if they are made to wait for class files because the node doing the distribution has been overwhelmed. In the exemplary embodiment, scalability is achieved by balancing the distribution tree such that any one node is not required to distribute class files to many other nodes, and by having all nodes cache the class files.

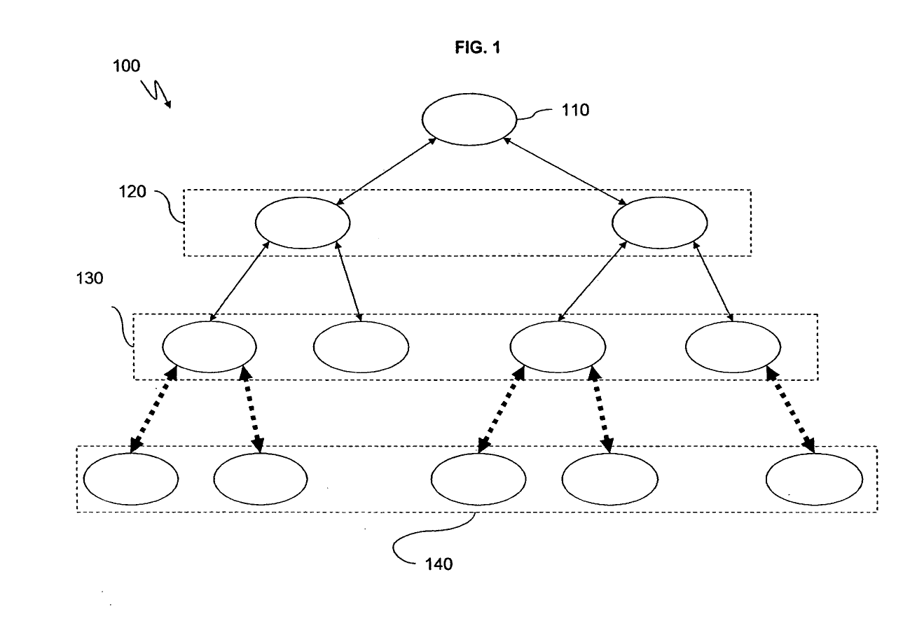

Now turning to FIG. 1, FIG. 1 illustrates an exemplary distribution tree in accordance with the exemplary embodiment.

The distribution tree 100 depicts a list of participating nodes represented by round circles. The list of participating nodes is not meant to be limiting, and the manner in which this list may be generated may be in accordance with the preferences of the implementer. As a non-limiting example, the list of participating nodes may be a static list. In another non-limiting example, the list of participating nodes may be generated dynamically by broadcasting a request for participation to the nodes and collecting the responses from the nodes (e.g., the user may have a light weight daemon running on all prospective clients (nodes) set up to handle such requests). The arrows represent distribution connections between the nodes in accordance with a parent to child relationship discussed herein.

For explanatory purposes, the first level nodes 120 may be considered children of the root node 110, and concurrently, the root node 110 may be considered the parent of the first level nodes 120. The second level nodes 130 may be considered the children of the first level nodes 120, and the first level nodes 120 may be considered the parents of the second level nodes 130. Likewise, nth level nodes 140 may be considered the children of n−1 level nodes [not shown]. The parent and children relationships of the participating nodes provide a framework for distributing, e.g., class files in the distribution tree 100.

In the exemplary embodiment, it may be assumed that a virtual machine (VM) is installed on each participating node, and the VM may be invoked remotely by a mechanism (e.g., by POE) for starting up the VMs on all participating nodes. The root node 110, containing the master VM, is given the list of participating nodes as well as network topology information. The details of the network topology information and the list of participating nodes provided to the root node 110 are not meant to be limiting and may be in accordance with the preferences of the implementer. As a non-limiting example, the details provided to the root node 110 may include latency rates between given nodes and/or bandwidth information.

Based on the network topology, a binomial broadcast tree, such as for example distribution tree 100, is created for (or by) the root node 110. If desired, a dynamic adaptive tree may be created. The distribution tree 100 is used only to distribute the class files, and the program is free to communicate between any nodes it chooses. As non-limiting examples, the program may be, e.g., an application that is running on all of the nodes 110-140 in the system, such as a Java application program specified by one or more class files (Java programs are compiled to class files). Class files may also be used for the standard Java libraries which may be invoked by a Java application program. Distributing the class files to all nodes 110-140 is required so that the nodes 110-140 can run the Java application program and any Java library methods that are used. As part of the execution of the Java application program, the nodes 110-140 may communicate with each other with information other than the class files, and it is contemplated that the nodes may communicate directly with each other in that case in the exemplary embodiment. The distribution tree 100 is configured to control and coordinate the distribution of the class files, but may also be used to efficiently distribute other information in accordance with the exemplary embodiment. The distribution tree 100 is not to limit communications between the nodes but to provide a means for distributing the class files. Moreover, the distribution tree 100 may also be referred to as a distribution map.

In the exemplary embodiment, a start up phase may be initiated. Depending on the user's preferences, e.g., a Java Virtual Machine (JVM) may either be continually up and running or a POE like framework may start up JVMs upon demand. Assuming, e.g., that a POE like framework is being used, the root node 110 VM may start up VMs on each of its immediate child nodes in the first level nodes 120. Once up and running, the root node 120 VM sends a copy of the distribution map (e.g., the distribution tree 100) to each of its children, with instructions for the children of the root node 120 to startup their children and propagate the distribution map. As non-limiting examples, the root node 110 sends the distribution map to the first level nodes 120, and the first level nodes 120 send the distribution map to the second level nodes 130, and ultimately the distribution map is sent to nth level nodes 140. Once the participating nodes start up their VMs, the participating nodes send a completion message to their parent. A node is considered to have finished its start up sequence only when all of its children have also finished their start up sequence.

In the exemplary embodiment, when the root node 110 VM starts running the user's program, this causes class loading, and the root node 110 VM will load the appropriate classes from the local file system. It is assumed that all needed class files are made available to the root node 110 VM from the local file system.

As a non-limiting example, eventually, a remote VM on one of the participating nodes may be required to run a method. The remote VM will be contacted and instructed to run the given method. The remote VM, however, has none of the required class files. Using the distribution map, the remote VM requests the class files from its parent that will in turn query its parent. This process will repeat until the parent node becomes the root node 110, from which the class files can be obtained. In the exemplary embodiment, the second level nodes 130 may be required to run a method but the second level nodes 130 do not have the class files. Accordingly, the second level nodes 130 query (their parent) the first level nodes 120 for the class files, and the first level nodes 120 query (their parent) the root node 110 for the class files.

When a node receives the class files, the class files are cached locally by the node and copied to the requesting child, until the original requesting node receives its copy. A table of cached class files is maintained in every node, and a time stamp is associated with this class file. If the class file is used locally, a bit marking it as ‘loadedLocally’ is set. If the class file is ever unloaded by the local VM of the node, the class file remains in the cache, but the ‘loadedLocally’ bit is cleared, and the time stamp updated. Anytime a child requests the class file and class file exists in the cache of the parent node, the time stamp is updated. Periodically, a sweep of the cache table is made, and any class file not marked ‘loadedLocally’ is expunged if over a certain age. This age is configurable and may be, e.g., 10 minutes. The cache for each participating node should be large enough to store all the class files required by the root node 110 VM, but the cache may be smaller at the cost of additional bandwidth.

In accordance with exemplary embodiments, particular methods, and the class files that contain them, may only be needed at certain stages of the execution of the Java application program. For example, some methods may only be executed when the program is starting up and may never be executed again. Other methods may be invoked more than once during the execution of the program, but there may be long intervals between the invocation of the method. Since each node 110-140 may have limitations on the amount of space available to cache class files, it is important to monitor whether previously cached classes are still in use. If cached classes are believed to no longer be in use, the cached classes can be dropped from the cache to save space or to free up space to cache other classes. If a class that was dropped from a cache is subsequently needed again, then the node 120-140 would have to again request that information from the parent (a process that could trigger requests right up to the root node 110, and result in the requested classes being re-cached in the intervening nodes 120-140).

Although levels for nodes (such as the first level nodes 120, second level nodes 130, etc.) have been discussed herein, it is understood that a plurality of individual nodes are operatively connected to each other such that the class files may be distributed in a parent to child relationship. It is understood that levels of nodes discussed herein are only used for explanatory purposes to represent a hierarchical relationship among the participating nodes for distributing the class files. Further, this hierarchical relationship may be used to distribute other items and is not limited to distributing only class files.

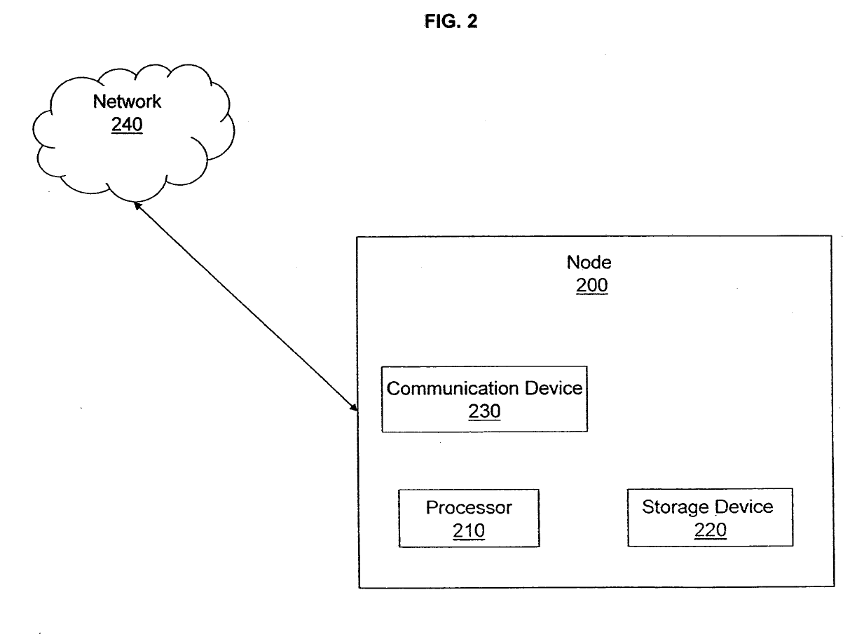

FIG. 2 illustrates a non-limiting example of a node in accordance with the exemplary embodiment. The node 200, which may be a computer, includes a processor 210 for executing instructions and storage device 200 (e.g., a cache for storing the class files). The node 200 may also have a communication device 230 for transmitting and receiving communications via a network 240. For example, the communication device 230 may be used to communicate with other participating nodes in accordance with the distribution tree 100 as discussed herein over the network 240, or the node 200 may be directly connected to other participating nodes (omitting the network 240).

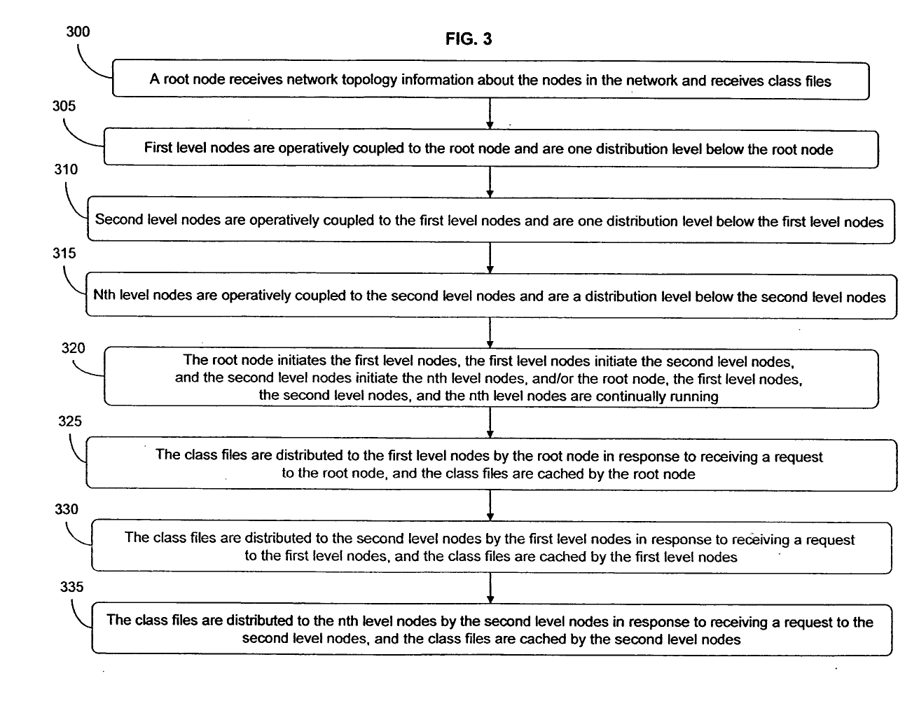

FIG. 3 illustrates a method for distributing class files without global file system support in accordance with the exemplary embodiment. In the exemplary embodiment, the method distributes class files to various recipients (e.g., nodes) in a network, and the recipients may be computers with processors for executing instructions.

A root node which may be a virtual machine receives network topology information about all nodes in the network, and the root node receives class files at 300. First level nodes are operatively coupled to the root node, and the first level nodes which may be virtual machines are one distribution level below the root node at 305. First level nodes are nodes that are considered children of the root node for distributing class files in accordance with a distribution map (e.g., the distribution tree 100), and the same applies by analogy for second level nodes and nth level nodes. Second level nodes, which may be virtual machines, are operatively coupled to the first level nodes, and the second level nodes are one distribution level below the first level nodes at 310.

Nth level nodes, which may be virtual machines, are operatively coupled to the second level nodes, and n represents a continuous succession of distribution levels for the nodes at 315. The class files are cached by the nth level nodes.

The root node initiates the first level nodes, the first level nodes initiate the second level nodes, and the second level nodes initiate the nth level nodes, and/or the root node, the first level nodes, the second level nodes, and the nth level nodes are continually running at 320.

The class files are distributed to the first level nodes by the root node in response to receiving a request to the root node, and the class files are cached by the root node at 325. The class files are distributed to the second level nodes by the first level nodes in response to receiving a request to the first level nodes, and the class files are cached by the first level nodes at 330.

The class files are distributed to the nth level nodes by the second level nodes in response to receiving a request to the second level nodes, and the class files are cached by the second level nodes at 335.

The capabilities of the exemplary embodiment can be implemented in software, firmware, hardware or some combination thereof.

As one example, one or more aspects discussed herein can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the exemplary embodiment can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the exemplary embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A system for distributing class files in a network to a plurality of recipients without global file system support, comprising:
a root node comprising a virtual machine, the root node being configured to receive network topology information concerning all nodes in the network and to obtain class files;
first level nodes comprising virtual machines, the first level nodes being operatively coupled to the root node and being one distribution level below the root node;
second level nodes comprising virtual machines, the second level nodes being operatively coupled to the first level nodes and being one distribution level below the first level nodes; and
nth level nodes comprising virtual machines, the nth level nodes being operatively coupled to the second level nodes and n being representative of a continuous succession of distribution levels for nodes through a last node in the network topology;
wherein at least one of:
the root node initiates the first level nodes, the first level nodes initiate the second level nodes, and the second level nodes initiate the nth level nodes, and
the root node, the first level nodes, the second level nodes, and the nth level nodes are continually running;
wherein in response to receiving a request to the root node, the root node distributes the class files to the first level nodes and caches the class files;
wherein in response to receiving a request to the first level nodes, the first level nodes distribute the class files to the second level nodes and cache the class files;
wherein in response to receiving a request to the second level nodes, the second level nodes distribute the class files to the nth level nodes and cache the class files; and
wherein the nth level nodes cache the class files.

2. The system of claim 1, wherein the class files represent a plurality of class files and each class file in the plurality of class files is time stamped when cached by the root node, the first level nodes, the second level nodes, and the nth level nodes;
wherein the root node, the first level nodes, the second level nodes, and the nth level nodes respectively maintain a table of the cached class files for the plurality of class files with corresponding time stamps for respective class files of the plurality of class files; and
wherein the root node is configured to determine the responsibilities, of distributing the plurality of class files in a scalable manner, for the root node, the first level nodes, the second level nodes, and the nth level nodes.

3. The system of claim 2, wherein in response to receiving respective requests to the root node, the first level nodes, the second level nodes, or the nth level nodes, the time stamp is updated in the respective tables.

4. A method for distributing class files in a network to a plurality of recipients without global file system support, comprising:
receiving network topology information about all nodes in the network by a root node comprising a virtual machine;
receiving class files by a root node;
operatively coupling first level nodes to the root node, the first level nodes comprising virtual machines and being one distribution level below the root node;
operatively coupling second level nodes to the first level nodes, the second level nodes comprising virtual machines and being one distribution level below the first level nodes;
operatively coupling nth level nodes to the second level nodes, the nth level nodes comprising virtual machines and n representing a continuous succession of distribution levels for the nodes,
wherein at least one of:
the root node initiates the first level nodes, the first level nodes initiate the second level nodes, and the second level nodes initiate the nth level nodes, and
the root node, the first level nodes, the second level nodes, and the nth level nodes are continually running;
distributing the class files to the first level nodes by the root node in response to receiving a request to the root node, wherein the class files are cached by the root node;
distributing the class files to the second level nodes by the first level nodes in response to receiving a request to the first level nodes, wherein the class files are cached by the first level nodes; and
distributing the class files to the nth level nodes by the second level nodes in response to receiving a request to the second level nodes, wherein the class files are cached by the second level nodes, and the class files are cached by the nth level nodes.

5. The method of claim 4, wherein the class files represent a plurality of class files and each class file in the plurality of class files is time stamped when cached by the root node, the first level nodes, the second level nodes, and the nth level nodes;
wherein the root node, the first level nodes, the second level nodes, and the nth level nodes respectively maintain a table of the cached class files for the plurality of class files with corresponding time stamps for respective class files of the plurality of class files; and
wherein the root node is configured to determine the responsibilities, of distributing the plurality of class files in a scalable manner, for the root node, the first level nodes, the second level nodes, and the nth level nodes.

6. The method of claim 4, wherein the method for distributing class files in the network to a plurality of recipients without global file system support is tangibly embodied on a computer readable medium including instructions for causing a computer to execute the method for distributing class files.
